(19) United States
(12) Patent Application Publication
(10) Pub. No.: US 2026/0145320 A1
(43) Pub. Date: May 28, 2026

(54) METHOD, RECORDING MEDIUM, AND SYSTEM FOR OPTIMALLY GENERATING ROBOT LEARNING DATA USING AI MODEL

(71) Applicant: Vision Space, Seoul (KR)

(72) Inventor: Wonseok Choi, Seongnam-si (KR)

(73) Assignee: Vision Space, Seoul (KR)

(21) Appl. No.: 18/963,277

(22) Filed: Nov. 27, 2024

(30) Foreign Application Priority Data
Nov. 26, 2024 (KR) 10-2024-0170916

(51) Int. Cl. B25J 9/16

(52) U.S. Cl. CPC B25J 9/163; B25J 9/161

(57) ABSTRACT

A method for optimally generating robot learning data using an AI model, includes: collecting and representing diverse data related to a robot's task and environment, integrating the data using a multimodal AI model, retrieving relevant information from a knowledge base using a Retrieval Augmented Generation (RAG) framework, generating robot learning data based on the integrated knowledge and retrieved information; and validating and refining the generated data.

### CROSS-REFERENCE TO RELATED APPLICATION

This application claims the benefit of priority to Korean Patent Application No. 10-2024-0170916, filed Nov. 26, 2024, the aforementioned priority application being hereby incorporated by reference in its entirety.

### TECHNICAL FIELD

This disclosure relates to the field of artificial intelligence, particularly to systems and methods for optimizing robot learning data and providing recommendations for robot models using multimodal AI and Retrieval Augmented Generation (RAG) techniques.

### BACKGROUND

Traditional robot learning often involves manual data collection and processing, which can be time-consuming and inefficient. Existing methods may also lack the ability to effectively leverage diverse data types, such as text, images, and 3D models, to optimize robot learning and model selection.

### BRIEF DESCRIPTION OF THE DRAWINGS

FIG. 1A shows a schematic diagram of a framework of a RAG generative AI engine that optimally generates or recommends robot learning data.

FIG. 1B shows a schematic diagram of a framework of a RAG generative AI engine that optimally generates or recommends robot learning data.

FIG. 1C shows a schematic diagram of a framework of a RAG generative AI engine that optimally generates or recommends robot learning data.

FIG. 1D shows a schematic diagram of a framework of a RAG generative AI engine that optimally generates or recommends robot learning data.

FIG. 2A shows a schematic diagram of a framework that accelerates inference speed and improves response speed according to an AI engine.

FIG. 2B shows a schematic diagram of a framework that accelerates inference speed and improves response speed according to an AI engine.

FIG. 3A shows a schematic diagram of a framework that collects and manages AI dictionary data and monitors model performance.

FIG. 3B shows a schematic diagram of a framework that collects and manages AI dictionary data and monitors model performance.

FIG. 3C shows a schematic diagram of a framework that collects and manages AI dictionary data and monitors model performance.

### DETAILED DESCRIPTION

The present disclosure provides an AI-powered system and method for optimizing robot learning data and providing recommendations for robot models. This addresses the limitations of traditional robot learning methods, which often rely on manual data collection and struggle to effectively leverage diverse data types, leading to inefficiencies and suboptimal model selection.

The system utilizes a multimodal Retrieval Augmented Generation (RAG) approach to overcome these challenges. This approach allows the system to process and integrate information from various data types, including text, images, and 3D models, enabling a more comprehensive understanding of robot learning tasks and facilitating the generation of optimized training data.

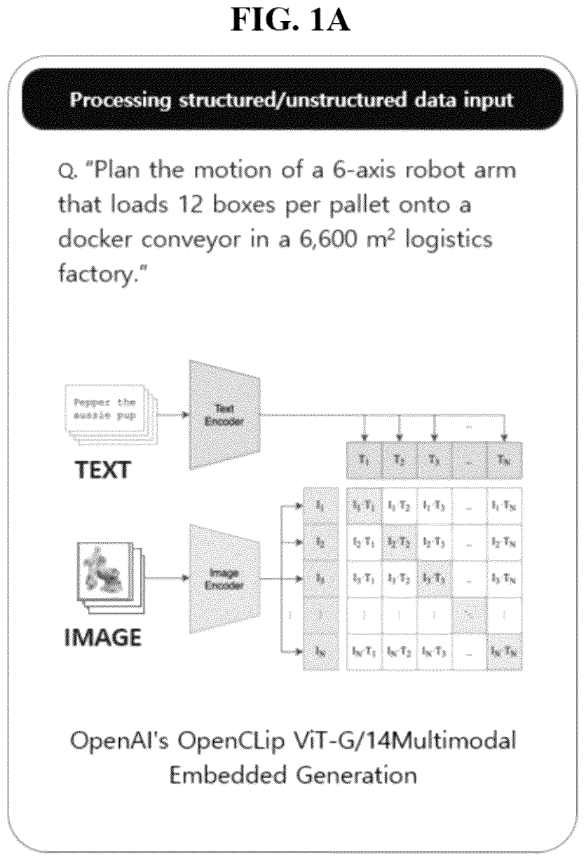

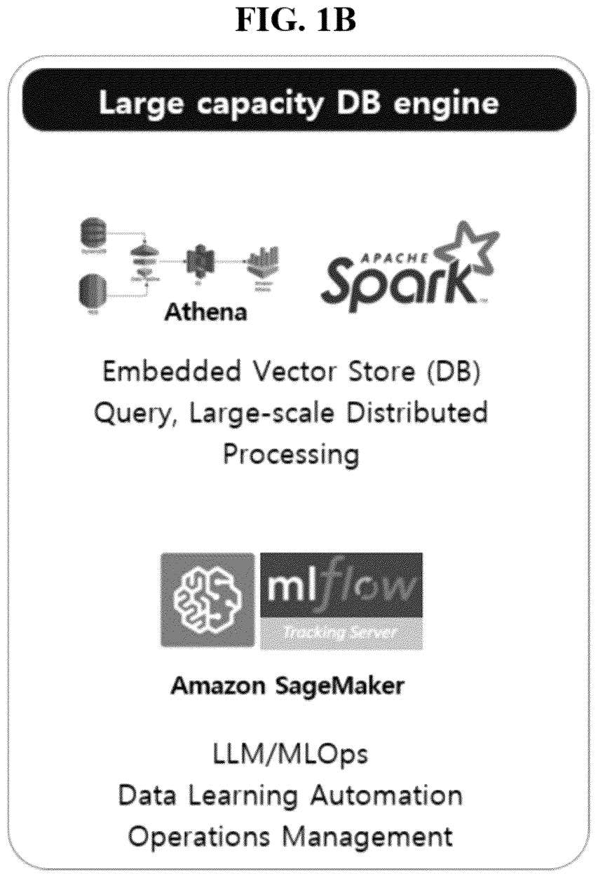

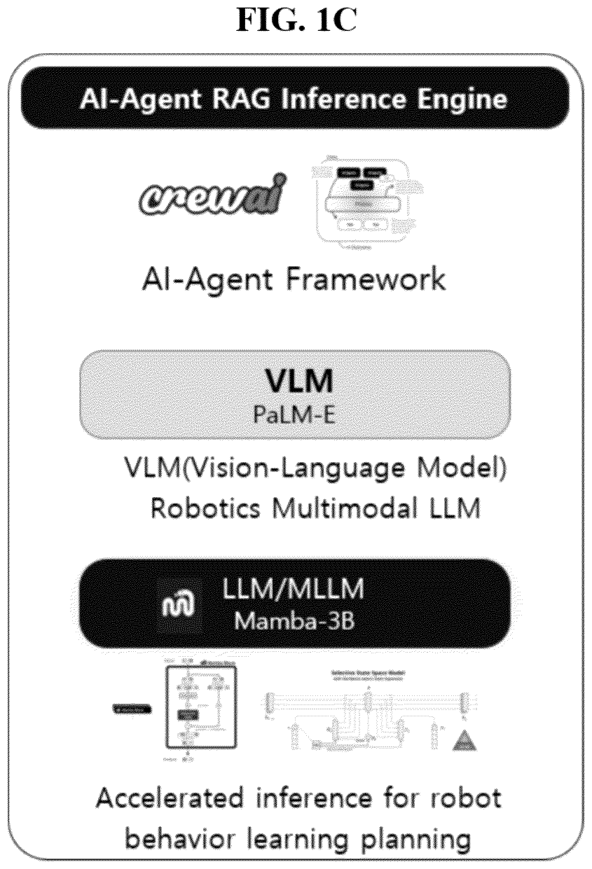

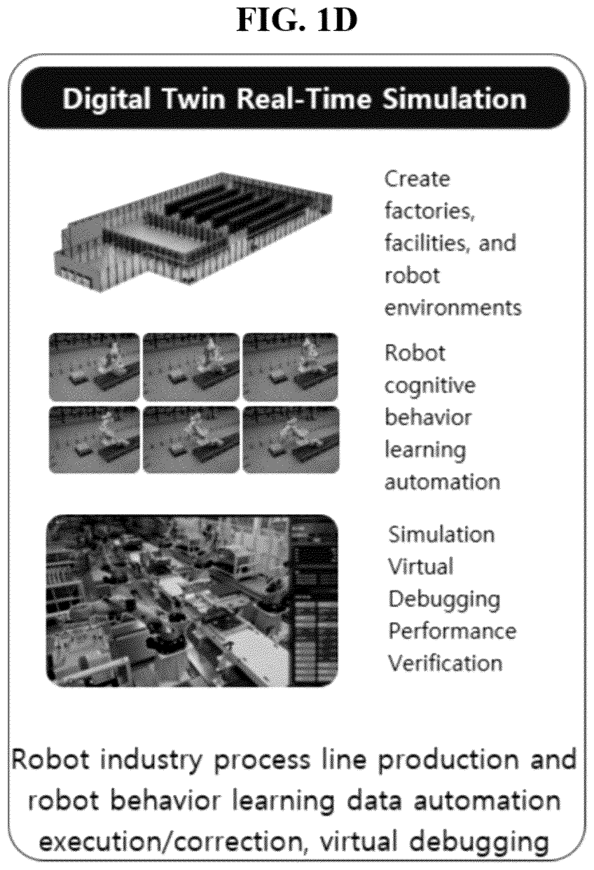

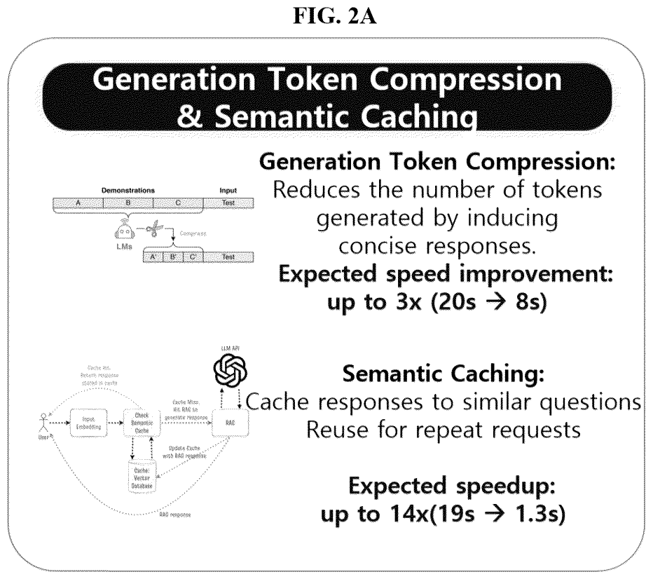

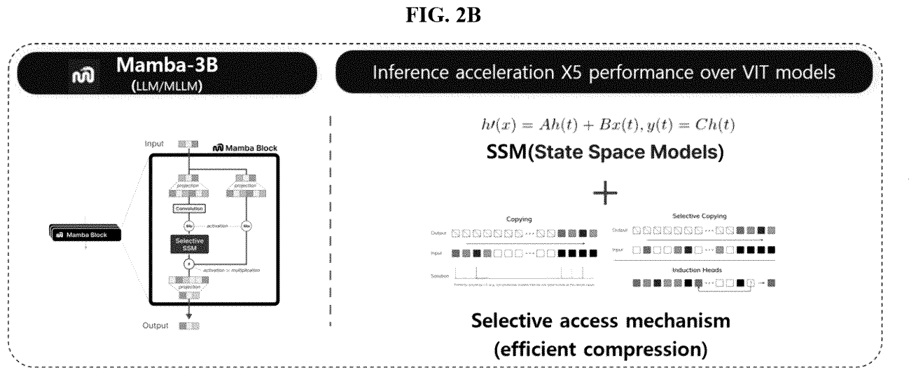

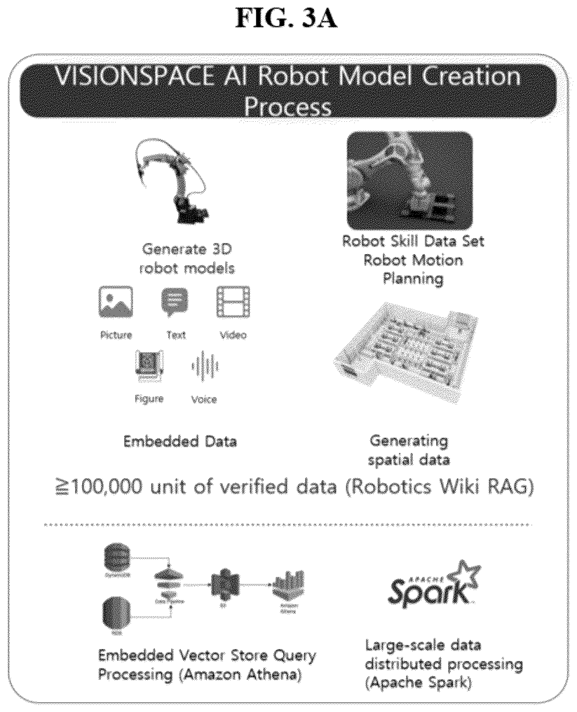

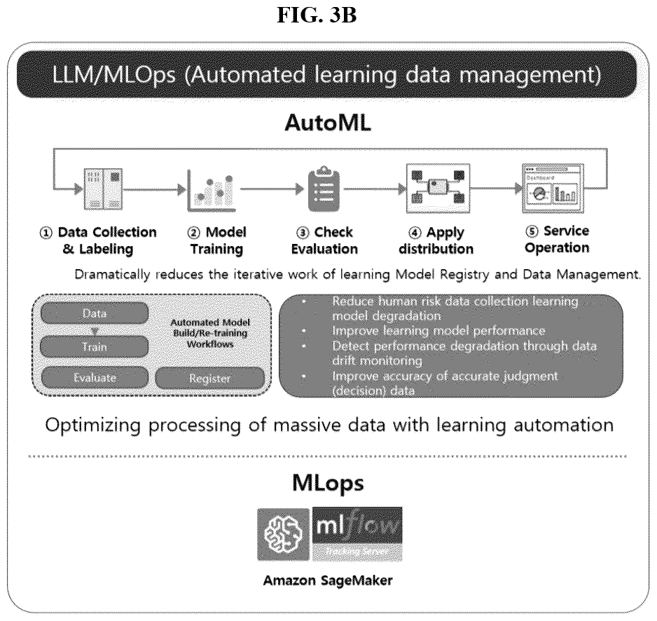

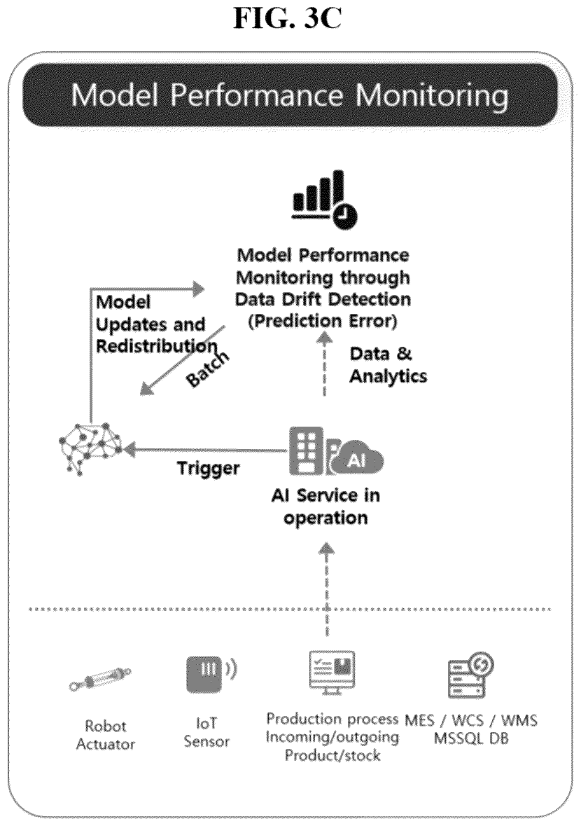

Hereinafter, FIGS. 1A to 1D illustrate a schematic diagram of a framework of a RAG generative AI engine that optimally generates or recommends robot learning data. Here, the framework can be described in the order of FIGS. 1A to 1D. In addition, FIGS. 2A and 2B illustrate a schematic diagram of a framework that accelerates an inference speed and improves a response speed according to an AI engine. In addition, FIGS. 3A to 3C illustrate a schematic diagram of a framework that collects and manages AI dictionary data and monitors model performance.

### System Architecture

The core components of the system work together to achieve the optimization and recommendation objectives:

Multimodal Search System: This component employs OpenAI's OpenCLip ViT-G/14 model, a powerful multimodal AI model. This model is capable of embedding both text and images into a shared vector space, allowing the system to process and search across these modalities simultaneously. For example, a user could search for “robot arm grasping a box” and the system would retrieve relevant information from both textual descriptions and images of robot arms performing grasping actions. This capability is crucial for efficiently identifying and retrieving relevant information from a database containing diverse data types.

Vector Database Management: The system utilizes a vector database to store and manage the embedded robot data generated by the multimodal search system. Specifically, it employs AWS Athena, a serverless interactive query service, and Apache Spark, a unified analytics engine for big data processing. This combination enables efficient storage, retrieval, and querying of high-dimensional embedding vectors. By storing the data in a vector database, the system can efficiently search for and retrieve similar or relevant data points based on their vector representations.

AI-Agent Personalized Recommendation System: This component leverages CrewAI, a platform for building and deploying AI agents, to provide personalized recommendations for robot models and data. The system analyzes user interactions, preferences, and search history to tailor its recommendations. For example, if a user frequently searches for information related to collaborative robots (cobots), the system will prioritize recommending cobot models and relevant datasets. This personalized approach ensures that users are presented with the most relevant and useful information for their specific needs.

VLM Multimodal Model: This component builds upon the foundation of the multimodal search system by incorporating 3D embedding in addition to the existing text and 2D embedding. This inclusion of 3D data provides a more comprehensive representation of robot models and their operating environments. By incorporating 3D information, the system can generate more accurate robot models, perform more precise searches, and offer more relevant recommendations.

Robot Industry RAG Optimization: This component focuses on optimizing the Robotics Wiki RAG model for efficient and effective retrieval of relevant information. It achieves this by combining the LLM Mamma architecture, a language model designed for fast inference, with token compression technology. This combination significantly accelerates the inference speed, learning process, and response time of the RAG model. This optimization is critical for ensuring that the system can quickly and efficiently process large volumes of data to provide timely recommendations.

Robotics RAG Wiki: This component ensures the accuracy and integrity of the data used for robot learning. It utilizes Vision-Language Models (VLM) and fine-tuning techniques specifically tailored to the robotics domain. This specialization helps to mitigate the “hallucination” problem often associated with large language models, where the model generates incorrect or nonsensical information. By grounding the model in robotics-specific knowledge and fine-tuning its parameters, the system can provide more reliable and accurate information for robot learning.

### System Operation

The System Operates in a Systematic Workflow:

Data Collection and Processing: The system begins by collecting both structured and unstructured data relevant to robot learning. This data can include textual descriptions, images, 3D models, sensor readings, and more. The system then processes this data using the multimodal search system to generate embeddings and store them in the vector database.

Model Training and Optimization: The processed data is then used to train and optimize robot models. The system can leverage various machine learning techniques and algorithms to train models for specific tasks, such as grasping, navigation, or assembly. The AI-agent personalized recommendation system can also suggest pre-trained models or recommend adjustments to existing models based on user needs and preferences.

Digital Twin Simulation: The system incorporates a digital twin real-time simulation environment to test and validate the performance of robot models before they are deployed in the real world. This simulation environment allows users to evaluate the behavior and performance of different robot models under various conditions and make necessary adjustments without the risks associated with real-world testing.

Deployment and Monitoring: Once a robot model has been validated in the simulation environment, it can be deployed to a physical robot. The system continues to monitor the performance of the deployed model and can provide feedback and recommendations for further optimization based on real-world data and user feedback.

This comprehensive approach ensures that robot learning is efficient, accurate, and tailored to specific user needs. By leveraging multimodal AI, RAG techniques, and personalized recommendations, the system enables the development and deployment of high-performing robot models for a wide range of applications.

What is claimed is:

1. A method for optimally generating robot learning data using an AI model, comprising:
collecting and representing diverse data related to a robot's task and environment;
integrating the data using a multimodal AI model;
retrieving relevant information from a knowledge base using a Retrieval Augmented Generation (RAG) framework;
generating robot learning data based on the integrated knowledge and retrieved information; and
validating and refining the generated data.

2. The method of claim 1, wherein the diverse data includes at least one of textual descriptions, images, 3D models, or sensor data.

3. The method of claim 1, wherein the multimodal AI model is a Vision-Language Model (VLM).

4. The method of claim 1, wherein the knowledge base is a Robotics Wiki.

5. The method of claim 1, wherein the generated robot learning data includes at least one of robot trajectories, control actions, or sensor readings.

6. The method of claim 1, further comprising fine-tuning the AI model to generate data that specifically addresses the needs of a robot learning task.

7. A non-transitory computer-readable recording medium storing instructions that, when executed by a computer, cause a computer to perform the method of claim 1.

8. A system for optimally generating robot learning data using an AI model, comprising:
a data collection module configured to collect diverse data related to a robot's task and environment;
a multimodal AI model configured to integrate the data;
a RAG framework configured to retrieve relevant information from a knowledge base;
a data generation module configured to generate robot learning data based on the integrated knowledge and retrieved information; and
a data validation module configured to validate and refine the generated data.
